(19) United States
(12) Patent Application Publication
(10) Pub. No.: US 2019/0172023 A1
(43) Pub. Date: Jun. 6, 2019

(54) Blockchain Probation

(71) Applicant: Ross Brandborg, Fargo, ND (US)

(72) Inventor: Ross Brandborg, Fargo, ND (US)

(21) Appl. No.: 15/996,436

(22) Filed: Jun. 2, 2018

(51) Int. Cl. G06Q 20/06; G06Q 20/38; H04L 9/06; G06Q 20/22

(52) U.S. Cl. CPC G06Q 20/065; G06Q 20/381; H04L 9/0618; G06Q 50/26; H04L 2209/38; H04L 2209/56; G06Q 20/22

(57) ABSTRACT

Probation supervision validation systems and methods are presented. Court ordered probation requirements are monitored through a blockchain with monitoring. The blockchain smart-contract can be considered a chronicle of person's path through probation. These court ordered transactions and the blockchain monitored probation provide a solid foundation for a judiciary based altcoin. A judicial based altcoin cryptocurrency and the natural blockchain and smart-contract probations or court order payments provide a solid foundation for blockchain based crypocurrency.

### RELATED APPLICATIONS

N/A

### FEDERALLY SPONSORED RESEARCH

N/A

### SEQUENCE LISTING OR PROGRAM

N/A

### TECHNICAL FIELD OF THE INVENTION

The present invention relates to a method of probation monitoring and more critically a cost reduction for supervision of probationers and the court probation system through the use of a blockchain. A byproduct of the blockchain probation is the integration of a proprietary cryptocurrency to a court ordered monetary payments.

### BACKGROUND OF INVENTION AND DEFINITIONS

Criminal probation systems have historically been used by courts and the judiciary (used interchangeably throughout this invention) to supervise the probationer after they are released from custody or as a method of punishment/supervision as all or part of a sentence. The supervision is necessary to ensure the probationer complies with court required conditions which often include evaluations by psychiatrists, meetings with probation officers, employment, and drug treatment (service providers). Meeting with probation officers is required so the officer can monitor and inform the court if there has been a violation of the court ordered probation conditions.

If a probationer does not complete the probation, by not complying with a condition of probation the court will traditionally revoke the probation often resulting in a new sentencing which may include harsher penalties. The ability of the court to monitor a probationer and the compliance with the probation conditions is paramount to the entire probation system. The monitoring of probation largely falls into the hands of individual probation officers which become adult babysitters. Adult babysitters are an enormous cost to the state, money better spent by the states on recidivism reduction these are areas that probation officers are educated for, instead of simply babysitting.

Probation agencies take on many forms there are some general characteristics that apply to all probation systems. The following definition of probation applies:
probation (n.)—The act of sentencing of a person convicted of a criminal offense and granting that person provisional freedom on the promise of good behavior and compliance with preset conditions, such as drug treatment.

In some jurisdictions, the term “probation” also includes parole, where a prisoner is released from prison and required to maintain good behavior to avoid going back to prison. For this invention's purposes probation and parole are treated equally. It is a program where offenders can be supervised, but remain in the community to work and spend time with their neighbors and family. Typically, a judge determines during sentencing whether probation is a suitable option for a convicted offender, and then prescribes certain requirements for that offender for his or her probation term. During probation terms (which can last anywhere from months to a decade or more), offenders are usually required to avoid breaking the law and to attend regular meetings with their probation officer. Other requirements might include drug and alcohol testing, community service, maintenance of employment or a job search, and various forms of counseling.

A Blockchain is a continuously growing list of records, called blocks, which are linked and secured using cryptography. Each block typically contains a cryptographic hash of the previous block, a timestamp and transaction data. By design, a blockchain is inherently resistant to modification of the data. It is “an open, distributed ledger that can record transactions between two parties efficiently and in a verifiable and permanent way”. For use as a distributed ledger, a blockchain is typically managed by a peer-to-peer network collectively adhering to a protocol for inter-node communication and validating new blocks. Once recorded, the data in any given block cannot be altered retroactively without the alteration of all subsequent blocks, which requires collusion of the network majority.

A hash function takes any input and produces an output of a specific size. The process of applying a hash function to some data is called hashing. The output of a hash function is called a hash. The basic feature of a particular hash function is the size and uniqueness of the output it produces. When a new block contains a unique hash from the previous block, it ties it back in a chain to the inception of the blockchain, making data on the blockchain immutable.

Blockchains are known for their use in cryptocurrency. Cryptocurrency's are digital assets designed to work as a medium of exchange that uses strong cryptography to secure financial transactions, control the creation of additional units, and verify the transfer of assets. Cryptocurrency is a kind of digital currency, virtual currency or alternative currency. Cryptocurrencies use decentralized control as opposed to centralized electronic money and central banking systems. The decentralized control of each cryptocurrency works through distributed ledger technology, typically a blockchain, that serves as a public financial transaction database.

Bitcoin, first released as open-source software in 2009, is generally considered the first decentralized cryptocurrency. Since then, over 4,000 altcoin (alternative coin) variants of bitcoin have been created.

In recent recent times, digital entrepreneurs have begun exploring both the use of the cryptographic security system cryptocurrencies based on stored data on the blockchain, to implement new systems, smart-contracts.

On the blockchain cryptocurrency transactions occur and may contain small programs known as scripts embedded into its inputs and outputs. These scripts can specify how and by whom the outputs of the transaction can be accessed, and these scripts are known as smart-contracts.

Smart-contracts are a technology that incorporates immutable agreements securely stored on a blockchain usually in script as in a computer program. Smart-contracts can be used to set up real estate transactions, banking transactions, stock options, or even public candidate vote casting. A predefined set of conditions are programmed with a computer language and stored on a blockchain such as Ethereum or Cardano.

An example of a simple smart-contract would be the requirement that a person completes a psychological examination (service provider) for the smart-contract to advance. One example of the advancement of the smart-contract could include forwarding money to another account such as the court or generating a report. The current practice is the service provider would be issued a private and public key for their role in the smart-contract. These keys give the service provider the ability to notify and alter the data on the smart-contract, acknowledging whether or not the psychological examination is completed.

Private and Public keys are well-known encryption techniques. However, any encryption method is applicable, and with the emergence of quantum computers, the quantum cryptography with quantum key distribution also is applicable. This is only an example, and for this invention, the type of cryptology is not important just that it is used allowing only proper actors to access and acknowledge smart-contracts.

### SUMMARY OF THE INVENTION

A method of combining court-ordered probation with smart-contracts stored on a blockchain.

A method of tying a proprietary altcoin cryptocurrency court orders, including probation and fine or payments.

### BRIEF DESCRIPTION OF THE DRAWINGS

FIG. 1 shows a flow chart of the general operation and transfer of cryptocurrency through a smart contract.

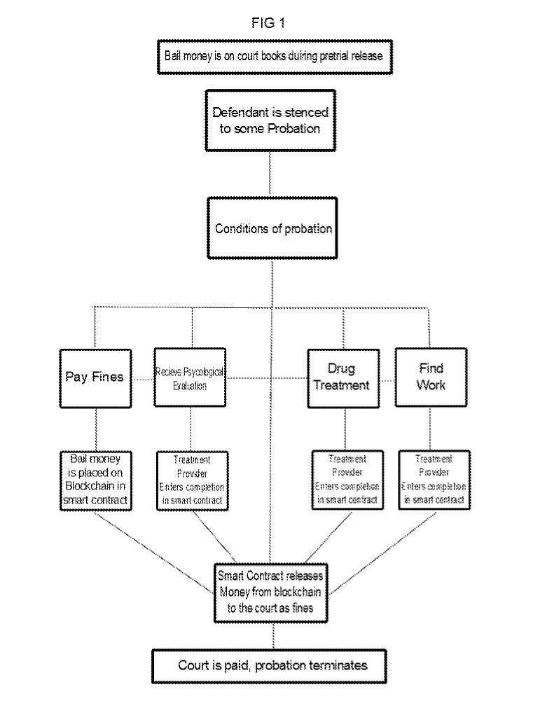

FIG. 2 shows a flow chart of the general operation and transfer of cryptocurrency and what happens in the event of non-compliance.

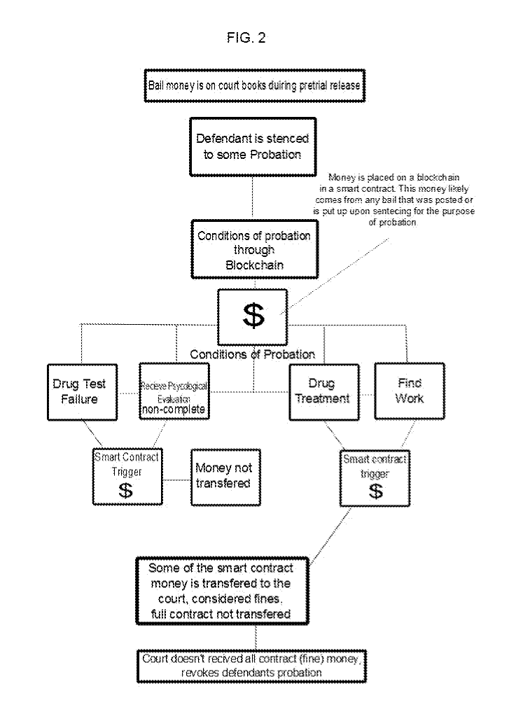

FIG. 3 shows a flow chart of a simplified version of the general operation and transfer of information and cryptocurrency through the proposed invention.

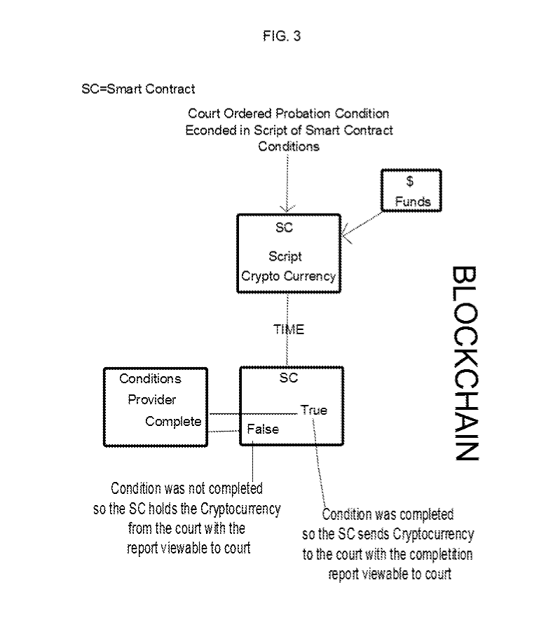

A complete understanding of the present invention is derived by referring to the detailed description and claims when considered in connection with the Figures.

Elements and steps in the figures are illustrated for simplicity and clarity and are not necessarily rendered according to any particular sequence. For example, steps that are performed concurrently or in different order are illustrated in the figures to help improve understanding of embodiments of the present invention.

### DETAILED DESCRIPTION OF THE PREFERRED EMBODIMENTS

While certain embodiments of the inventions are described, these embodiments are presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions.

The invention consists of combining a smart-contract naturally with a blockchain such as Ethereum or Cardano and applying that technology to probation, pretrial release, or parole. Another example could be a school placing a student on probation with requirements. The advantage of the invention is the smart-contract in connection with a blockchain can handle the monitoring of the probation conditions.

A person would be put on probation (Probationer). The Judge would order conditions of that probation; those conditions could include but not limited to:
a. results of blood alcohol tests;
b. results of breath alcohol tests;
c. results of drug tests;
d. global position as a function of time;
e. a position relative to a court-ordered boundary or zone;
f. driving performance;
g. personal communications;
h. personal aid to others;
i. training;
j. earned education credit;
k. medical and psychological examinations an treatment;

The service providers conducting the condition requirements would have keys for the smart-contracts. Upon the Probationers completion of a condition, the service provider would advance the smart-contract using their issued keys. If a condition is not met, the service provider could use their keys to note the completion failure in the smart-contract.

According to one embodiment of the present invention, there is provided a smart-contract computer-implemented blockchain method of controlling the visibility and performance of probation, the method comprising the steps:
(a) After a criminal conviction, a Defendant is sentenced, and that sentence involves some time on probation;
(b) A smart-contract (or series of smart-contracts) is created on a blockchain corresponding to the probationer's conditions ordered by the court.
   i) The smart-contract or series of smart-contracts are funded.
   ii) Encryption keys are issued.
(c) The Defendant is required to fulfill the smart-contracts.
   i) As the Probationer completes the requirements of probation, the service providers use their encryption keys to notify the smart-contracts.
(d) During the probation period and the clearing of the smart-contracts by the service providers' the court or court officer can use its own keys to monitor the progress.

In a second embodiment of this invention, the method is based on the payment of fines. After a criminal conviction, fines are normally owed to the court. Courts generally collect fines in one of several ways.
a. The fine is taken from previously posted bail.
b. The fine is collected in one payment after sentencing.
c. The fine is collected by the court in a payment plan over a period of time from the Defendant.
d. The fine is collected by the probation officer over a period of time. (along with probation fees)

All courts monitor the payment of fines, and the payment of fines is usually a condition of probation. The court can monitor a probationer without a supervising probation officer by:
(a) After a criminal conviction, a Defendant is sentenced, and that sentence involves some time on probation;
(b) A smart-contract (or series of smart-contracts) is created on a blockchain corresponding to the probations conditions ordered by the court.
   i) The smart-contract or series of smart-contracts are funded through the previously posted bail, collected from the Defendant, or a series of contract funding deadlines are set up.
   ii) Encryption keys are issued.
(c) The Defendant is required to fulfill the smart-contracts.
   i) As the Defendant completes the requirements of probation, the service providers use their encryption keys to advance the smart-contracts.
(d) As the smart-contracts are cleared by the service providers, funds from the smart-contracts are transferred to the court which monitors the payments as fines. (court monitoring of fines is fairly a standard practice) Because the releases of the funds to the court are smart-contract dependent, the fines are only paid if the Defendant clears the probation requirements as ordered. If a requirement is not met, they would naturally be notified of the failure of fine payment.

No probation officer is an advantage to the court. For any method described in this invention, automatic reports can be generated by the smart-contracts and available to the court to review at any time.

Even if the courts don't view a report on the competition or lack of completion of a condition, the courts monitor the payment of fines. Therefore the failure of a probationer to finish paying the fines means they have not completed their probation conditions.

In one embodiment of the invention, probation is simply monitored with a blockchain and not money or cryptocurrency is needed. The immutable blockchain maintains all the probationer's progress throughout probation is accessible by the court and can be monitored with any agent with the proper key credentials.

In one embodiment of the invention, the probationer's blockchain probation provides funds through the smart-contract for restitution that may be owed by the probationer. Or the probationer's activities can earn cryptocurrencies for a charity.

### EXAMPLE

Smart-contract example: Probation

A smart-contract that allows the following account-holders to interact:
a court setting the probation and which we'll call thecourt (as this is where funds should end up)
a person on probation who has to comply with conditions and pay fines to court: probationer
other account holders who provide services to the Probationer: thesponsors
a cryptocurrency node that is mining the blockchain, verifying transactions: theminer

Our contract:
is scripted (contract) by the theCourt and funded by depositing money intended for court fines in a holding account (the actual funds will usually come from the probationer, but are set by theCourt)
when creating the contract, the theCourt dictates what services are needed from thesponsors
the probationer then in complying with probation uses thesponsors services, such as drug treatment. Thesponsors indicate the probationer's progress by calling a function on the smart-contract which transfers cryptocurrency from the holding account to theCourt, where it is held until further notice or used to pay down the owing fines.
during the lifetime of the contract, it is encrypted, and only theCourt and possibly the probationer can see the progress on the smart-contract.

Then one of two things can happen:
The probationer completes probation requirements as planned and thesponsors instructs the contract to transfer all of the funds to theCourt;
Or the probationer does not complete the requirements the sponsors do not instruct the contract to transfer the funds and theCourt know the fines are not paid, this a probation revocation proceeding likely takes place.

In one embodiment of this invention a cryptocurrency is not necessary for the implantation of a blockchain. Blockchain probation could be implemented using an informational blockchain that does not relate to currency but contains all the informational tools described for the automatic monitoring of probation. Treatment provider would use encryption keys and enter information on a smart-contract that is live on a blockchain same as described earlier, however without the need for miners or cryptocurrency. A simple informational blockchain could be especially important as it may take courts an incremental procedure to move over to a blockchain-cryptocurrency probation system.

In another embodiment of this invention, the court sentences an individual but then the monitoring and follow through of that sentencing is handed off to a private organization to monitor and enforce the sentence or probation. This private organization will then monitor the probationer s sentence through a blockchain as described previously in this invention.

In another embodiment of this invention the blockchain is used for child support payments that have been ordered by the court. A person ordered to pay child support can made payment through the blockchain and smart-contracts can monitor the payments and notify the court of payment status.

Essentially all payments made to the judiciary can be made through a blockchain as described in this invention.

In another embodiment of this invention the cryptocurrency used for blockchain probation its own proprietary altcoin cryptocurrency issued for that blockchain, thus not relying on other cryptocurrency's price fluctuations. This cryptocurrency would be on its own blockchain with smart-contract viability. A proprietary cryptocurrency based on the judiciary and the inherent need for payments requires a stable cryptocurrency. Millions of dollars each day are paid into the judicial system around the world through probation and fine payments. Blockchain cryptocurrency streamlines the payment system through the use of blockchains and a proprietary cryptocurrency tied to these payments.

Altcoins have been attached to many companies and other organizations. However for an altcoin to be successful, it must be used. Altcoin's progression from startup to a viable currency requires its use. Through its use, the miners validate transactions which creates more coins and thus progresses the currency. With the judiciary requiring payment through an altcoin naturally creates a stable and viable currency.

While certain embodiments of the inventions have been described, these embodiments have been presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, those skilled in the art will appreciate that in various embodiments, the actual steps taken in the processes shorn may differ from those shown in the figures. Depending on the embodiment, certain of the steps described in the example above may be removed, others may be added, and the sequence of steps may be altered and/or performed in parallel. Although this disclosure describes examples, those skilled in the art will recognize that the various embodiments disclosed apply to the judicial system and its connection to blockchains. Also, the features and attributes of the specific embodiments disclosed above may be combined in different ways to form additional embodiments, all of which fail within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method of probation comprising of implementing a blockchain to monitor probation.

2. A method of conducting probation as in claim 1 further comprising;
entering the conditions of probation into a smart-contract,
funding the smart-contract on a blockchain with a cryptocurrency.

3. A method as in claim 2 further comprising;
funding the smart-contract on the blockchain with money previously posted as bail or from the probationer.

4. A method as in claim 2 further comprising;
using results reported from the smart-contract and thus the blockchain to monitor probation.

5. A method as in claim 4 further comprising;
the smart-contract triggering and automatically paying the probationers fines to the court as probation conditions are met.

6. A method as in claim 4 further comprising;
the court monitoring the fine payments as a way of monitoring that probation conditions are met.

7. A method of conducting probation as in claim 2 further comprising;
funding the smart-contract with a proprietary cryptocurrency specific to blockchain probation.

8. A method of creating proprietary altcoin cryptocurrency with blockchain infrastructure specifically tied to payments through or to a judiciary system.

9. A method of monitoring probation as in claim 1 further comprising;
the court assigning the sentence and or probation to a private company which then uses a blockchain to monitor the probationer.

10. A method of the courts or judicial system of monitoring any litigants through a blockchain.

11. A method as in claim 10 further comprising;
the judiciary using a blockchain to monitor payments.
